(19) United States
(12) Patent Application Publication
(10) Pub. No.: US 2003/0101031 A1
(43) Pub. Date: May 29, 2003

(54) Method for generating at least one sequence of random numbers approximated to sequences of numbers of a 1/f noise

(76) Inventor: Georg Denk, Rosenheim (DE)

Correspondence Address: LERNER AND GREENBERG, P.A., Post Office Box 2480, Hollywood, FL, 33022-2480, US

(21) Appl. No.: 10/289,827

(22) Filed: Nov. 7, 2002

(30) Foreign Application Priority Data
Nov. 7, 2001 (DE) 100 54 200.3

(51) Int. Cl. G06F 17/10

(52) U.S. Cl. 703/2

(57) ABSTRACT

A method for generating a sequence of random numbers approximated to sequences of numbers of a 1/f noise is based on utilizing (0,1)-normally-distributed random numbers to make possible the generation of an arbitrary-length sequence of random numbers representing a good approximation to random numbers of a 1/f noise while limiting the computation time for determining such sequences of random numbers.

### BACKGROUND OF THE INVENTION

### FIELD OF THE INVENTION

The invention relates to a method for generating at least one sequence of random numbers approximated to sequences of numbers of a 1/f noise.

Random numbers of a 1/f noise can be used, for example, in a transient circuit simulation that takes account of noise influences. A 1/f noise is understood to mean a stochastic process with a specific frequency spectrum that can be described by the equation:

$$S ( f ) α \frac{1}{{f}^{β}} , β ∈ ] 0.1 [ .$$

1/f noise sources are suitable for modeling noise influences in a multiplicity of technical and physical systems and also for systems for estimating and predicting events on the financial markets. In particular, many electronic components, such as pn diodes and MOS field-effect transistors, for example, have 1/f noise sources.

German Patent DE 100 01 124 C1 discloses a circuit configuration and also a method for reducing the 1/f noise of MOSFETs in an electronic circuit, in particular, in an integrated circuit that has at least one MOSFET. In such a case, one, a plurality or all of the MOSFETs are assigned at least one DC voltage source for setting one or a plurality of constant operating points of the MOSFET or MOSFETs.

U.S. Pat. No. 5,719,784 to Clark et al. describes a device and a method for the analysis of data that are obtained from tissue samples and are present in frequency spectra. In such a case, the non-random nature of cell and tissue microstructures purportedly corresponds to a 1/f noise. This reference explicitly states that there are no known mathematical models for generating 1/f noise.

U.S. Pat. No. 6,188,294 to Ryan et al. discloses a method in which white noise is coupled differentially into an amplification stage. In such a case, the white noise is amplified differentially by an amplifier that generates a first signal with a white noise. The 1/f components of the noise and also a displacement voltage present are substantially removed from this first signal, thereby producing a second signal with a white noise. A random sequence signal is, then, generated by a decision being taken as to whether the generated second signal in each case assumes the values of zero or one.

U.S. Pat. No. 6,081,228 to Leimer discloses a method for estimating the phase noise component in a GPS receiver, which can, then, be removed before the tracking of each satellite. This reference also discloses a method for reducing the phase noise in a multichannel radio receiver, in which the multiplicity of receiver channels derives a clock signal from a source circuit.

### SUMMARY OF THE INVENTION

It is accordingly an object of the invention to provide a method for generating an arbitrary-length sequence of random numbers that is approximated to sequences of random numbers of a 1/f noise that overcomes the hereinafore-mentioned disadvantages of the heretofore-known devices and methods of this general type and that is carried out rapidly and with low computation complexity that does not grow beyond measure for long sequences of numbers. Also provided is an improved method for the simulation of a technical system that is subject to a 1/f noise. Finally provided is a computer system with a computer program for determining sequences of random numbers approximated to sequences of numbers of a 1/f noise that can be executed rapidly and that takes up only few resources of a computer system. The technical system can be an electronic component, such as a pn diode, a MOS field-effect transistor, or a phase-locked loop.

According to the invention, the problem of noise simulation in the modeling of the system to be simulated is converted into the problem of generating a sequence of random numbers. In such a case, the correlations of these random numbers are determined and used for simple and accurate generation of the sequences of random numbers.

The invention's method for generating at least one sequence of random numbers of a 1/f noise firstly provides the following steps:

determination of a desired spectral value β; and

determination of an intensity constant const.

The characteristics of the 1/f noise to be simulated are, thus, defined.

Afterward, the number of random numbers to be generated (which are approximated to random numbers of a 1/f noise), a start value for a running variable n used for the simulation, and a value for a window size d are defined.

The invention provides the loop-like repetition of steps until the desired number of elements y(n) of one or more vectors y of length n has been calculated from 1/f-distributed random numbers. The first two of these steps to be repeated in a loop-like manner are the step of incrementing the present value of the running variable n by the value 1 and the step of defining a simulation time step [tₙ₋₁; tₙ].

The remaining method steps to be repeated in a loop-like manner are dependent on the value of the running variable n. Before each loop-like iteration of the method steps, a check is made to determine whether the value of the running variable n is made less than or greater than the defined value of the window size d. Respectively different method steps are, then, provided for the case (n<d) or (n≧d).

To simplify the notation, the following indexing of the submatrices and subvectors is performed hereinafter: the indexing relates to the associated points in time and, thus, does not begin with 1 for submatrices and subvectors in the case (n>d). By way of example, a d-dimensional vector is indexed by (n−d+1), (n−d+2), . . . , n. The n-th element is the element indexed by n, that is to say, the last component of the d-dimensional vector. The same applies analogously to submatrices.

For the case (n<d), the following steps are repeated in a loop-like manner:

determination of the elements Cᵢⱼ of a covariance matrix C(n) of dimension (n×n) according to the following specification:

Cᵢⱼ:=const·(−|tⱼ−tᵢ|^{β+1}+|tⱼ₋₁−tᵢ|^{β+1}+|tⱼ−tᵢ₋₁|^{β+1}−|tⱼ₋₁−tᵢ₋₁|^{β+1}),

i,j=1, . . . , n

determination of the inverted covariance matrix C⁻¹(n)=B(n) of dimension (n×n);

determination of a variable σ in accordance with the specification σ=sqrt(1/e(n,n)), where sqrt designates the “square root” function and where e(n,n) designates that element of the inverted covariance matrix B(n) that is indexed by (n,n);

determination of a (0,1)-normally-distributed random number that forms the n-th component of a vector x of length n;

formation of a variable μ from the first (n−1) components of the n-th row of the inverted covariance matrix B(n) and from the (n−1) elements of the vector y that were calculated for a preceding (n−1)-th simulation time step, to be precise in accordance with the following specification:

$$μ := - \frac{{y}_{( n - 1 )}^{T} \cdot {{B}_{=}}_{\cdot , n}}{{{B}_{=}}_{n , n}}$$

where y₍ₙ₋₁₎ designates the first (n−1) components of the vector y, where B_{•,n} designates the first (n−1) components of the n-th row of the inverted covariance matrix B(n), and where B_{n,n} designates that element of the inverted covariance matrix B(n) that is indexed by (n,n); and

calculation of an element y(n) of a vector y of length n from 1/f-distributed random numbers according to the following specification:

Y(n)=x(n)*σ+μ.

For the case (n≧d), the following steps are repeated in a loop-like manner:

determination of the elements Cᵢⱼ of a covariance matrix C(n) of dimension (d×d) according to the following specification:

Cᵢⱼ:=const·(−|tⱼ−tᵢ|^{β+1}+|tⱼ₋₁−tᵢ|^{β+1}+|tⱼ−tᵢ₋₁|^{β+1}−|tⱼ₋₁−tᵢ₋₁|^{β+1}),

i,j=(n−d+1), . . . , n

determination of the inverted covariance matrix C⁻¹(n)=B(n) of dimension (d×d),

determination of a variable σ in accordance with the specification:

σ=sqrt(1/e(n,n)),

where sqrt designates the “square root” function and where e(n,n) designates that element of the inverted covariance matrix B(n) that is indexed by (n,n);

determination of a (0,1)-normally-distributed random number that forms the n-th component of a vector x of length n;

formation of a variable μ from the first (d−1) components of the n-th row of the inverted covariance matrix B(n) and from the last (d−1) elements of the vector y that were calculated for a preceding (n−1) simulation time step, to be precise in accordance with the following specification:

$$μ := - \frac{{γ}_{( n - 1 )}^{T} \cdot {{B}_{=}}_{\cdot , n}}{{{B}_{=}}_{n , n}}$$

where y₍ₙ₋₁₎ designates the last (d−1) components of the vector y, where B_{•,n} designates the first (d−1) components of the n-th row of the inverted covariance matrix B(n), and where B_{n,n} designates that element of the inverted covariance matrix B(n) that is indexed by (n,n); and

calculation of an element y(n) of a vector y of length n from 1/f-distributed random numbers according to the following specification:

Y(n)=x(n)*σ+μ.

A basic concept of the present invention resides in providing a method that makes it possible to generate sequences of random numbers—based on 1/f-distributed random numbers—progressively, that is to say, element by element. In such a case, the method ensures that each newly generated random number depends correctly in the stochastic sense on the previously generated random numbers based on 1/f-distributed random numbers. As a result, it is possible to generate the respectively required random numbers in the course of the numerical simulation of a circuit.

A further basic concept of the invention lies in limiting the dimension of the covariance matrix C(n) required for generating the random numbers and the inverse B(n) of the matrix to the value of a predeterminable window size d and, thus, keeping the computation time of the method according to the invention within limits. Such a concept is based on the insight that the complexity for setting up and inverting the covariance matrix C(n) grows at least quadratically with the number of time steps to be taken into account. In the absence of limitation of the dimension of the covariance matrix C(n) and the inverse B(n) thereof, the computation complexity for long simulation intervals, as are necessary, for example, for the simulation of phase locked loops, grows to a disproportionate size so that a transient noise simulation over the desired period of time becomes impossible. Restricting the growth of the covariance matrix C(n) and the inverse B(n) thereof advantageously restricts the computation time required for the simulation of 1/f noise sources and also the amount of memory required.

The method according to the invention accordingly ensures an arbitrary-length simulation of technical systems. Proceeding from 1/f-distributed random numbers that have already been generated, additional 1/f-distributed random numbers can be generated in a simple manner. In such a case, it is possible to place a simulation on the results of previously simulated time intervals. This so-called restart capability represents a very important property for simulation practice. It is precisely for 1/f noise sources that this can only be achieved with difficulty because random numbers that simulate a 1/f noise source for a certain time interval depend on random numbers of earlier time intervals that have already been determined numerically.

The present invention also allows the use of an adaptive step size control without, thereby, significantly increasing the computation times for the simulation of a technical system. Such an adaptive step size control considerably increases the precision and the computation time efficiency in the numerical determination of the dynamic range of a simulated technical system. The provision of variable step sizes also enables an adaptation to present system dynamic ranges, which increases the accuracy of the simulations.

The invention uses the theory of conditional probability densities to generate a 1/f-distributed random number that ensures the stochastic relationship between this random number and the random numbers that have already been generated and are required for preceding simulation steps.

In another refinement of the method according to the invention, a vector C₁₂^{T}(n) and a matrix C₂₂(n) are determined from the covariance matrix C(n) according to:

$$C ( n ) = ( \frac{{c}_{11} ( n )}{{c}_{12} ( n )} \vert \frac{{c}_{12}^{T} ( n )}{{C}_{22} ( n )} ) .$$

An inverted covariance matrix C⁻¹(n)=B(n) of dimension (d×d) is determined utilizing an inverted matrix C₂₂⁻¹(n−1) by Schur complement techniques. A vector b₁₂(n) and a matrix B₂₂(n) are determined from the inverted covariance matrix B(n) according to:

$$B ( n ) = ( \frac{{b}_{11} ( n )}{{b}_{12} ( n )} \vert \frac{{b}_{12}^{T} ( n )}{{B}_{22} ( n )} ) .$$

An inverted matrix C₂₂⁻¹(n) is determined according to:

C₂₂⁻¹(n)=(I_{d-1}−b₁₂(n)c₁₂^{T}(n))⁻¹·B₂₂(n),

where I_{d-1} is a unit matrix of dimension ((d−1)×(d−1)).

In a particularly advantageous refinement of the method according to the invention, the inverted covariance matrix B(n) is not completely recalculated for every loop-like repetition of the relevant method steps, rather, the results that have already been determined are used to calculate the covariance matrix C(n−1) and the inverted covariance matrix B(n−1).

In such a case, instead of the step of determining the inverted covariance matrix C⁻¹(n)=B(n) of dimension (d×d), the following steps are provided:

determination of a vector c₁₂^{T}(n−1) and a matrix C₂₂(n−1), from the covariance matrix C(n−1):

$$C ( n - 1 ) = ( \frac{{c}_{11} ( n - 1 )}{{c}_{12} ( n - 1 )} \begin{matrix}{c}_{12}^{T} ( n - 1 ) \\ {C}_{22} ( n - 1 )\end{matrix} ) .$$

In such a case, c₁₁(n−1) is that element of C(n−1) that is indexed by (n−d+1, n−d+1), that is to say, the element at the top left, c₁₂^{T}(n−1) is the vector including the last (d−1) elements of that row of C(n−1) that is indexed by (n−d+1), that is to say, the topmost row, and C₂₂(n−1) is the bottom right submatrix of dimension (d−1)×(d−1) of C(n−1).

Determination of the inverted covariance matrix C⁻¹(n−1) B(n−1) of dimension (d×d). In such a case, B(n−1) is already known from the preceding step.

Determination of the vector b₁₂(n−1) and the matrix B₂₂(n−1) from the inverted covariance matrix B(n−1):

$$B ( n - 1 ) = ( \begin{matrix}{b}_{11} ( n - 1 ) \\ {b}_{12} ( n - 1 )\end{matrix} \begin{matrix}{b}_{12}^{T} ( n - 1 ) \\ {B}_{22} ( n - 1 )\end{matrix} ) .$$

In such a case, b₁₁(n−1) is that element of B(n−1) that is indexed by (n−d+1, n−d+1), that is to say, the element at the top left, b₁₂^{T}(n−1) is the vector including the last (d−1) elements of that row of B(n−1) that is indexed by (n−d+1), that is to say, the topmost row, and B₂₂(n−1) is the bottom right submatrix of dimension (d−1)×(d−1) of B(n−1).

Determination of the inverted matrix C₂₂⁻¹(n−1), according to the following specification:

C₂₂⁻¹(n−1)=(I_{d-t}−b₁₂(n−1)c₁₂^{T}(n−1))⁻¹·B₂₂(n−1)

where I_{d-1} represents the unit matrix of dimension ((d−1)×(d−1));

determination of the inverted covariance matrix B(n) of dimension (d×d) using the inverted matrix C₂₂⁻¹(n−1) by Schur complement techniques.

Such an embodiment of the invention avoids an explicit recalculation—which is highly computation-time-intensive with a rising dimension of the covariance matrix C(n)—of the inverted covariance matrix B(n) for each value of the running variable n. Instead of this, the inverted covariance matrix B(n) is determined using Schur complement techniques known to the person skilled in the art, recourse being had to the variables C₂₂(n−1), c₁₂^{T}(n−1), C₂₂⁻¹(n−1), B₂₂(n−1), b₁₂^{T}(n−1) that have already been determined.

With the aid of the Sherman-Morrison-Woodbury formula, the inverted submatrix C₂₂⁻¹(n−1) can be calculated without explicit inversion. The Sherman-Morrison-Woodbury formula is disclosed in G. H. Golub and C. F. van Loan. Matrix Computations. John Hopkins University Press, page 51, 2nd edition, 1989.

Simulations that require a high number of time steps are actually made possible in the first place by this embodiment of the invention. The implementation of the invention's concept of limiting the computation time of the method according to the invention resides in the fact that if the covariance matrix C(n) reaches and exceeds a freely selectable window size d, a window having a size (d×d) is placed over the covariance matrix C(n), which window selects a bottom right submatrix of dimension (d×d) from the covariance matrix.

With each further time step, this window (d×d) is shifted by one position toward the bottom right within the covariance matrix C(n) so that, after reaching the freely selectable window size d, only the window (d×d) of the covariance matrix C(n) is considered and only this part of the covariance matrix C(n) is inverted. The computation complexity is, thus, kept virtually constant for rising sizes of the covariance matrix C(n). The complexity for shifting the covariance matrix window with the size (d×d) can also be kept low by virtue of the updating of the inverted covariance matrix B(n) by the above formula instead of the explicit inversion.

In a particularly advantageous refinement of the method according to the invention, q sequences of random numbers of a 1/f noise are calculated simultaneously, in which case, instead of the steps that are to be repeated in a loop-like manner:

determination of a (0,1)-normally-distributed random number that forms the n-th component of a vector x of length n,

formation of a variable μ from the first (d−1) components of the n-th row of the inverted covariance matrix B(n) and from the last (d−1) elements of the vector y that were calculated for a preceding (n−1) simulation time step, to be precise in accordance with the following specification:

$$μ := - \frac{{γ}_{( n - 1 )}^{T} \cdot {{B}_{=}}_{\cdot , n}}{{{B}_{=}}_{n , n}}$$

where y₍ₙ₋₁₎ designates the first (d−1) components of the vector y, B_{•,n} designates the first (d−1) components of the n-th row of the inverted covariance matrix B, and where B_{n,n} designates that element of the inverted covariance matrix B that is indexed by (n,n);

calculation of an element y(n) of a vector y of length n from 1/f-distributed random numbers according to the following specification:

Y(n)=x(n)*σ+μ

the following steps are provided:

determination of q (0,1)-normally-distributed random numbers x_{k,n} that form the respective last component of the vectors xₖ of length n, where k=1, . . . , q. In this case, it should be taken into account that the respective first (n−1) components of the vectors xₖ had already been calculated in the step before;

Formation of q variables μₖ in accordance with the following specification:

$${μ}_{k} := - \frac{{γ}_{( n - 1 ) , k}^{T} \cdot {{B}_{=}}_{\cdot , n}}{{{B}_{=}}_{n , n}}$$

where y_{(n-1),k} designates the last (d−1) components of the vector yₖ that were calculated for a preceding simulation time step, B_{•,n} designates the first (d−1) components of the n-th row of the inverted covariance matrix B, and B_{n,n} designates that element of the inverted covariance matrix B that is indexed by (n,n). This is carried out for k=1, . . . , q;

calculation of q elements y_{k,n} that form the respective n-th component of the vector yₖ of length n from 1/f-distributed random numbers; to be precise, according to the following specification:

y_{k,n}=x_{k,n}*σ+μₖ

where k=1, . . . , q.

The q vectors yₖ (k=1, . . . , q) of length n from 1/f-distributed random numbers are, particularly, advantageously disposed in a matrix NOISE, which, in a simulation, specify the 1/f noise influences of a system to be simulated.

According to the invention, the concept for the simulation of 1/f noise is based on the following train of thought. The dynamic range of a system exposed to stochastic influences is adequately modeled by a stochastic process. For the simulation of such a system dynamic range, generally individual random realizations or paths of the underlying stochastic process are calculated numerically. For the simulation of systems with 1/f noise sources, it is a matter of numerically calculating paths of stochastic integrals of the form

$${\int }_{0}^{t} Y ( s ) {η}_{\frac{1}{f}} ( s ) ⅆ s .$$

In such a case, s designates the integration variable, t, as an upper integration limit, designates the time,

$${η}_{\frac{1}{f}} ( s ) ⅆ s$$

designates a 1/f noise source, and Y(s) designates a stochastic process that describes the temporal dynamic range of a variable, e.g., the electrical voltage in the circuit simulation.

If B_{FBM}(s) is used to designate that stochastic process whose derivative (mathematically: derivative in the distribution sense) produces the 1/f noise process

$${η}_{\frac{1}{f}} ( s ) ,$$

then the stochastic integral to be calculated can be written as

$${\int }_{0}^{t} Y ( s ) {η}_{\frac{1}{f}} ( s ) ⅆ s = {\int }_{0}^{t} Y ( s ) ⅆ {B}_{FBM} ( s ) . \qquad ( 1.1 )$$

The integral of the right-hand side is to be interpreted as a Riemann-Stieltjes integral of the stochastic process Y(s) with the process B_{FBM}(s) as integrator. This integral can be approximated by a sum by breaking down the integration interval [0, t] in accordance with 0≡t_{\ddot{0}}<tᵢ< . . . <t≡t into n disjoint subintervals [tᵢ, tᵢ₋₁], i=1, . . . n:

$${\int }_{0}^{t} Y ( s ) ⅆ {B}_{FBM} ( s ) \approx {\sum }_{i = 1}^{n} Y ( {t}_{i - 1} ) [ {B}_{FBM} ( {t}_{i} ) - {B}_{FBM} ( {t}_{i - 1} ) ] \qquad ( 1.2 )$$

This sum is a random variable. The dependence on the result ω of the random experiment has been consistently omitted.

A process B_{FBM}(s) whose generalized derivative has a 1/f spectrum is disclosed in R. Barton and H. V. Poor. Signal Detection in Fractional Gaussian Noise. IEEE Transactions and Information Theory, pages 943-959, 1988, for example, under the name “Fractional Brownian Motion”. B_{FBM}(s) is a Gaussian stochastic process and, as such, is completely characterized by its expected value

E(B_{FBM}(s))=0∀sεR (1.3)

and by its covariance function

Cov(B_{FBM}(s),B_{FBM}(t))=const·(|s|^{β+1}+|t|^{β+1}−|t−s|^{β+1}) (1.4)

The method according to the invention for the demand-oriented generation of suitable random numbers reduces the simulation of 1/f noise influences substantially to the generation of realizations of the random variable [B_{FBM}(tᵢ)−B_{FBM}(tᵢ₋₁)], that is to say, of growths of Fractional Brownian Motion.

The present invention allows the required realizations of the random variable ΔB_{FBM}(i) to be generated on line, i.e., in the course of the progressive integration of the system equations. This results in two requirements imposed on the method:

(a) the length n of the sequence of random numbers {ΔB_{FBM}(1), . . . , ΔB_{FBM}(n)} must remain variable during a simulation run. In particular, it must be possible, at any time, to lengthen the simulation. Such a characteristic is designated as restart capability and implies the capability of the method to generate the additional random numbers required for this purpose such that they correlate correctly with the subsequence that has already been generated; and

(b) Let tᵢ be the time presently reached in the course of a simulation. The time interval [tᵢ, tᵢ₊₁], that is to say, the step size of the next integration step, must, then, be able to be determined from the instantaneous system dynamic range, that is to say, adaptively.

The invention meets both requirements by specifying a specification as to how a realization of {ΔB_{FBM}(1), . . . , ΔB_{FBM}(n)}, that is to say, a sequence of random numbers, can be generated progressively, i.e., element by element. In such a case, the step size Δt₁:=tᵢ−tᵢ₋₁ is freely selectable for each new random number.

Firstly, the approach is investigated for so-called “conditional densities.”

The distribution of the random variable vector (ΔB_{FBM}(1), . . . , ΔB_{FBM}(n)) is first considered.

Because the individual random variables ΔB_{FBM}(i) represent growths of a Gaussian stochastic process, the random variable vector (ΔB_{FBM}(1), . . . , ΔB_{FBM}(n)) is an n-dimensional random variable having Gaussian distribution and is, thus, completely determined by its (n-dimensional) expected value E and its covariance matrix C. The two variables can be calculated from the formulae (1.3) and (1.4) as

E(ΔB_{FBM}(i))=0, (3.5)

i=1, . . . , n

Cᵢⱼ:=Cov(ΔB_{FBM}(i),ΔB_{FBM}(j))=const·(−|tⱼ−tᵢ|^{β+1}+|tⱼ₋₁−tᵢ|^{β+1}+|tⱼ−tᵢ₋₁|^{β+1}−|tⱼ₋₁−tᵢ₋₁|^{β+1}), (3.6)

i,j=1, . . . , n.

The online method according to the invention will now be specified in the form of a complete induction.

The induction start and, thus, the starting point of the method is the realization of a real-value Gaussian distribution with expected value 0 and variance

$${\sum }_{11} = 2 \cdot const \cdot {\vert Δ {t}_{1} \vert}^{β + 1} .$$

In the sense of an induction end, we must specify how we extend a realization of (ΔB_{FBM}(1), . . . , ΔB_{FBM}(n−1)) by a realization of ΔB_{FBM}(n) to produce overall a realization of (ΔB_{FBM}(1), . . . , ΔB_{FBM}(n)). To simplify the notation, the already “scrambled” subsequence of random numbers shall be designated by (y₁, . . . ,yₙ₋₁)=:y₍ₙ₋₁₎^{T} and the realization of ΔB_{FBM}(n) that is yet to be scrambled shall be designated by yₙ.

The problem can now be formulated as follows: let there be an n-dimensional mean-free Gaussian random variable Z with the covariance matrix C. Let the first n−1 elements of a realization of Z be already scrambled and known in the form of a random number vector y₍ₙ₋₁₎. What is now sought is the distribution from which the n-th element yₙ must be drawn in order to complete y₍ₙ₋₁₎ to form a realization y=(y₍ₙ₋₁₎,yₙ) of Z.

A solution to such a task can be found if we consider the conditional probability density f(yₙ|y₍ₙ₋₁₎) for yₙ under the condition that y₍ₙ₋₁₎ is already fixed. This variable can be calculated in the present case of a Gaussian normal distribution as

$$f ( {y}_{n} \vert {y}_{( n - 1 )} ) = \frac{1}{\sqrt{2 π \frac{1}{\underline{\underline{{C}_{n , n}^{- 1}}}}}} exp \{ - \frac{1}{2 \frac{1}{\underline{\underline{{C}_{n , n}^{- 1}}}}} {( {y}_{n} - μ )}^{2} \} . \qquad ( 3.7 )$$

In this case, the variable C_{n,n}¹ results from the following notation of the inverted covariance matrix C⁻¹:

$${\underline{\underline{C}}}^{- 1} = ( \begin{matrix}{\underline{\underline{C}}}_{( n - 1 )}^{- 1} & {\underline{\underline{C}}}_{• , n}^{- 1} \\ {( \underline{\underline{{C}_{• , n}^{- 1}}} )}^{T} & {\underline{\underline{C}}}_{n , n}^{- 1}\end{matrix} ) , \qquad ( 3.8 )$$

where C₍ₙ₋₁₎⁻¹εR^{(n-1)×(n-1)}, where C_{•,n}⁻¹εR⁽ⁿ⁻¹⁾, and where C_{n,n}⁻¹εR.

The variable μ stands for

$$μ := - \frac{{γ}_{( n - 1 )}^{T} \cdot {\underline{\underline{C}}}_{• , n}^{- 1}}{{\underline{\underline{C}}}_{n , n}^{- 1}} \qquad ( 3.9 )$$

The conditional density f(yₙ|y₍ₙ₋₁₎) is thus the probability density of a Gaussian normal distribution with mean μ and variance

$$variance \frac{1}{{\underline{\underline{C}}}_{n , n}^{- 1}} .$$

So that the above variance exists, C_{n,n}⁻¹≠0 must hold true. This is ensured on account of the following argumentation:

C and C⁻¹ have the same intrinsic directions and inverse eigenvalues. An eigenvalue 0 of the matrix C⁻¹ would, thus, result in an infinite variance of the random variable vector (ΔB_{FBM}(1), . . . , ΔB_{FBM}(n)). It can, therefore, be assumed that all eigenvalues of C⁻¹ are not equal to zero. Because the eigenvalues of C⁻¹ are always non-negative, the following, thus, holds true: the matrix C⁻¹ is symmetrical and positive definite.

By renaming the coordinate axes, this matrix can be brought from the form (3.8) to the following form:

$${\overline{\underline{\underline{C}}}}^{ - 1} := ( \begin{matrix}{\overline{\underline{\underline{C}}}}_{n , n}^{ - 1} & {( {\underline{\underline{\overline{C}}}}_{• , n}^{ - 1} )}^{T} \\ {\overline{\underline{\underline{C}}}}_{• , n}^{ - 1} & {\overline{\underline{\underline{C}}}}_{( n - 1 )}^{ - 1}\end{matrix} ) , \qquad ( 3.10 )$$

This matrix is, likewise, symmetrical and positive definite in terms of its construction. In accordance with the Sylvester criterion for symmetrical and positive definite matrices, it follows from this that (\overline{C}⁻¹)₁₁=C_{n,n}⁻¹>0, and the assertion is shown. Through the method according to the invention, the simulation of

$$\frac{1}{f}$$

noise sources is reduced to the generation of random numbers with Gaussian distribution.

To generate a random number yₙ that correlates with an already generated sequence y₍ₙ₋₁₎ in the manner demanded, the inverted covariance matrix C⁻¹ (an n×n matrix) is required. Strictly speaking, only knowledge of the n-th row of this matrix is necessary, that is to say, knowledge of ((C_{*,n}⁻¹)^{T}, C_{n,n}⁻¹). As can be read from formula (3.6), the covariance matrix C depends on the breaking up of the simulation interval [0, tₙ] into disjoint subintervals (step sizes) [tᵢ₋₁, tᵢ]. In particular, the last column of C (identical to the last row due to the symmetry of C) depends on tₙ and, thus, on the present step size Δtₙ=tₙ−tₙ₋₁.

The top left (n−1)×(n−1) submatrix \tilde{C} of the n×n covariance matrix C is precisely the covariance matrix for a random number sequence of length n−1. Such a covariance matrix already had to be determined and inverted for the calculation of y₍ₙ₋₁₎ (or for the calculation of the last element y₍ₙ₋₁₎). To accelerate the method, it is, thus, possible to have recourse to incremental methods for matrix inversion, e.g., by the Schur complement.

To determine the inverted covariance matrix C⁻¹(n+1)=B(n+1) of the next time step (n+1), it is necessary to consider the covariance matrix C(n) and the inverted covariance matrix C⁻¹(n)=B(n) thereof as follows:

$$\begin{matrix}C ( n ) = ( \frac{{c}_{11} ( n )}{{c}_{12} ( n )} \vert \frac{{c}_{12}^{T} ( n )}{{C}_{22} ( n )} ) & ( 3 \cdot 11 ) \\ B ( n ) = ( \frac{{b}_{11} ( n )}{{b}_{12} ( n )} \vert \frac{{b}_{12}^{T} ( n )}{{B}_{22} ( n )} ) & ( 3.12 )\end{matrix}$$

In this case, the following holds true:

B(n)·C(n)I_{d} (3.13)

where I_{d} designates the d-dimensional unit matrix. From the relationship B(n)·C(n)=I_{d}, the following results with the above representations of the covariance matrix C(n) and the inverted covariance matrix B(n):

b₁₂(n)c₁₂^{T}(n)+B₂₂(n)C₂₂(n)=I_{d-1} (3.14)

and, thus:

C₂₂⁻¹(n)=(I_{d-1}−b₁₂(n)c₁₂^{T}(n))⁻¹·B₂₂(n) (3.15)

With the aid of the Sherman-Morrison-Woodbury formula disclosed in G. H. Golub and C. F. van Loan. Matrix Computations. John Hopkins University Press, page 51, 2nd edition, 1989, the inverted submatrix C₂₂⁻¹(n) of the submatrix C₂₂(n) can be calculated without explicit inversion of (I_{d-1}−b₁₂(n)c₁₂^{T}(n))⁻¹ as:

$${C}_{22}^{- 1} ( n ) = {( {I}_{d - 1} + \frac{1}{1 - {b}_{12} ( n ) {c}_{12}^{T} ( n )} {b}_{12} ( n ) {c}_{12}^{T} ( n ) )}^{- 1} \cdot {B}_{22} ( n ) \qquad ( 3.16 )$$

The corrected inverse C₂₂⁻¹(n) of the covariance matrix C₂₂(n) is, thus, available, which can be extended by Schur complement techniques, for example, in the next time step (n+1).

The invention is also realized in a method for the simulation of a technical system that is subject to a 1/f noise. In such a case, random numbers that have been determined by a method according to the invention are used in the modeling and/or in the definition of the variables present on input channels of the system.

The invention is, furthermore, realized in a computer program for executing a method for generating at least one sequence of random numbers approximated to random numbers of a 1/f noise.

In such a case, the computer program is configured such that, after the inputting of a desired spectral value β, after the inputting of the number of random numbers to be generated, after the inputting of an intensity constant const, after the inputting of a start value for a running variable n and after the inputting of a value for a window size d, a method according to the invention can be carried out in an embodiment described above. In such a case, a sequence of random numbers that are each approximated to a 1/f noise is output as a result of the method. Such a sequence of random numbers can be used to model noise influences in a multiplicity of technical and physical systems.

The computer program improved according to the invention results in improved applicability of the method to a multiplicity of technical and physical systems, in simple and effective generation of sequences of random numbers and run time improvement, and also in optimization of computing power.

The computer program according to the invention, furthermore, results in a broad application spectrum of the method for a multiplicity of technical and physical systems and simple and effective generation of random numbers approximated to random numbers of a 1/f noise, a fast run time, and an optimal use of computing power being ensured.

The invention additionally relates to a computer program that is contained on a storage medium, which is stored in a computer memory, which is contained in a random access memory or which is transmitted on an electrical carrier signal.

Furthermore, the invention relates to a data carrier with such a computer program and to a method in which such a computer program is downloaded from an electrical data network, such as from the Internet, for example, onto a computer connected to the data network.

Other features that are considered as characteristic for the invention are set forth in the appended claims.

Although the invention is illustrated and described herein as embodied in a method for generating at least one sequence of random numbers approximated to sequences of numbers of a 1/f noise, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a block circuit diagram of a technical system to be simulated;

FIG. 2 is a structogram illustrating a determination of sequences of random numbers of a 1/f noise according to the invention;

FIGS. 3A to 3F are numerical matrices illustrating an example calculation for a simulation time step [t₄, t₅]=[2.75, 3.00] according to the invention; and

FIGS. 4A to 4C are numerical matrices illustrating an example calculation for a sixth simulation time step [t₅, t₆]=[3.000, 4.000] according to the invention.

### DESCRIPTION OF THE PREFERRED EMBODIMENTS

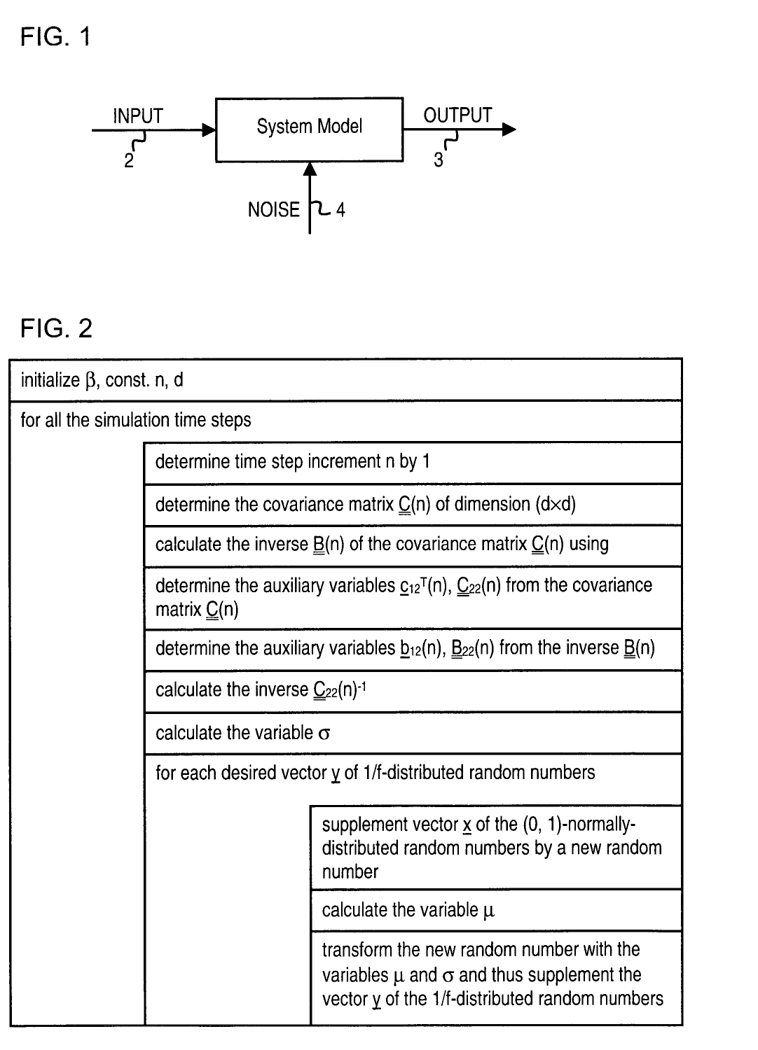

Referring now to the figures of the drawings in detail and first, particularly to FIG. 1 thereof, there is shown a schematic illustration of a noisy system that is to be simulated.

The system is described by a system model 1, which is indicated as a box and describes the system behavior. The system behavior results from the input channels 2, which are also designated as vector INPUT and from the output channels 3 that are also designated as OUTPUT. Furthermore, a system-dictated noise is provided, which is present on noise input channels 4 and which is also designated as vector or as matrix NOISE. A matrix NOISE is present when the noise is taken into account with a plurality of channels, each column of the matrix NOISE containing a vector of noise values that are present on a noise input channel.

The noise on the noise input channels 4 is, preferably, interpreted as a noise-dictated alteration of the system model 1.

The behavior of the input channels 2 and of the output channels 3 can be described by a system of differential equations or by a system of differential-algebraic equations to make possible reliable predictions of the system behavior.

For each time step of the simulation of the system shown in FIG. 1, a vector OUTPUT of the output channels 3 is calculated for a vector INPUT present on the input channels 2 and for a vector NOISE present on the noise input channels 4.

For the simulation over a relatively long period of time, the vectors INPUT, OUTPUT, NOISE are expediently specified as a matrix, a respective column k of the relevant matrix containing the values of the corresponding time series of the relevant INPUT, OUTPUT, NOISE.

FIG. 2 illustrates how a respective vector yₖ is attained that forms a column k of the matrix NOISE for the noise input channels 4 of the system model 1. Each vector yₖ serves for the simulation of a noise source.

In a first step a desired spectral value β, an intensity constant const, and a window size d are defined. Furthermore, the counter n of the present simulation time interval is set to a start value, which is assumed to be (n≧d) in the exemplary embodiment considered.

The following sequence of computation steps is, then, carried out progressively for each simulation time step.

Firstly, the present simulation time step is defined. Equivalently thereto, it is also possible to define the end of the present simulation time step, thereby producing the next point in time under consideration.

Afterward, the counter n of the present simulation time step is incremented by one.

The covariance matrix C(n) of dimension (d×d) is subsequently determined according to equation (3.6). In the case (n>d), only the bottom right (d×d)-sized window of the covariance matrix C(n) is determined. The variables i, j of equation (3.6) assume the values i,j=(n−d+1), . . . , n in such a case. In the case (n=d), the entire covariance matrix C(n) is determined for the values i,j=1, . . . , n.

During the determination of the covariance matrix C(n), recourse is had to the values of the ((d−1)×(d−1))-sized window of the covariance matrix C(n−1) calculated during the previous iteration of the method steps, which window is disposed at the bottom right in the covariance matrix C(n−1). The values of such a window form the values disposed in the top left ((d−1)×(d−1))-sized window in the covariance matrix C(n) that is to be newly determined. Accordingly, in the recalculation, only the values of the last row and of the last column of the covariance matrix C(n) are explicitly recalculated.

In the next step of the method according to the invention, the inverse B(n) of the covariance matrix C(n) is determined.

This is calculated explicitly for the case (n≦d), for example, by a Cholesky decomposition. For the case (n>d), the inverse B(n) is determined using Schur complement techniques to increase the efficiency. In such a case, recourse is had to the variables C₂₂(n−1), C₂₂⁻¹(n−1), c₁₂^{T}(n−1), B₂₂(n−1), and b₁₂(n−1) determined in the last iteration of the method steps.

In the next two method steps, the auxiliary variables C₂₂(n) and c₁₂^{T}(n) are determined from the covariance matrix C(n) using equation (3.11) and the auxiliary variables B₂₂(n) and b₁₂(n) are determined from the inverse B(n) using equation (3.12).

The inverted submatrix C₂₂⁻¹(n) is determined by equation (3.15) using the auxiliary variables c₁₂^{T}(n), B₂₂ (n), and b₁₂(n). This inverted submatrix C₂₂⁻¹(n) is required in the respective next iteration of the method steps for calculating the inverted covariance matrix B₂₂(n).

Next, the variable σ is calculated from the formula

σ=sqrt(1/e(n,n))

where sqrt designates the “square root” function and where e(n,n) designates that element of the inverted covariance matrix B(n) that is indexed by (n,n).

In addition, a value of a (0,1)-normally-distributed random variable Xₖ is extracted and the vector xₖ of the normally distributed random numbers is, thereby, supplemented. The extracted random number has the expected value 0 and the variance 1. This step is carried out for each noise source to be simulated.

Furthermore, a variable μₖ is formed. It is formed, for (n≦d), from the first (n−1) components of the n-th row of the inverted covariance matrix B(n) and from the sequence of (n−1) 1/f-distributed random numbers that were calculated for the preceding (n−1) simulation time steps.

For (n>d), μₖ is formed from the first (d−1) components of the n-th row of the inverted covariance matrix B(n) and from the sequence of the last (d−1) 1/f-distributed random numbers that were calculated for the preceding (n−1) simulation time steps.

For such a purpose, the procedure is in accordance with formula (3.9). This step is carried out separately, in the case of a plurality of noise sources k present, for each noise source k to be simulated.

Finally, that element of the matrix NOISE is calculated whose column index k specifies the noise source to be simulated and whose row index is equal to n. The present simulation time step is designated thereby. The presently calculated element r(k,n) of the matrix NOISE represents a random number that, together with the superjacent (n−1) elements of the same column k of NOISE, forms a vector yₖ of length n from 1/f-distributed random numbers. Such a vector yₖ serves for the simulation of one of the noise sources for the first n simulation time steps.

Each element yₖ of the n-th row of NOISE is, then, determined, based upon equations (3.7)-(3.9), from the last random number xₖ of the vector x and the variables μₖ and σ, to be precise, according to the following specification:

yₖ=xₖ*σ+μₖ.

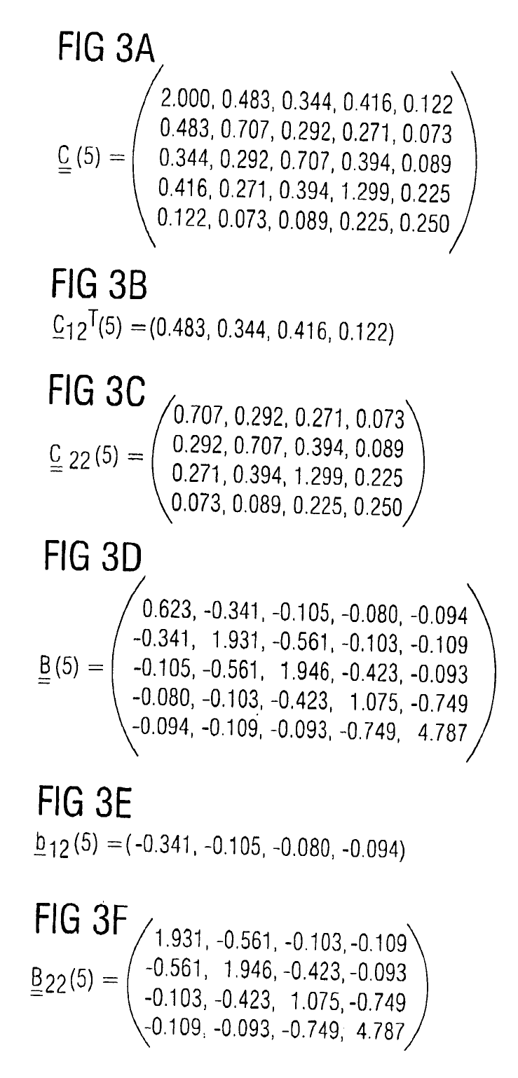

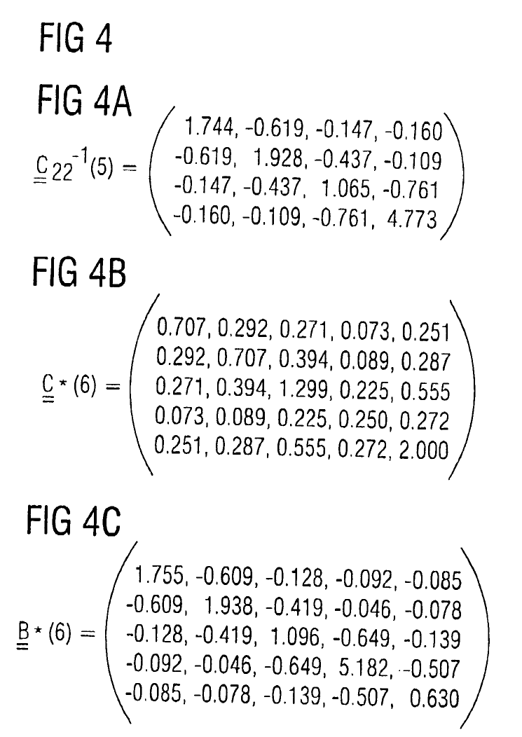

FIGS. 3A to 3F and 4 show the implementation of the method according to the invention based upon a concrete calculation example.

In the calculation example, a sequence of random numbers that are based on random numbers of a 1/f noise is generated. Such a sequence of random numbers is stored in a vector y. The generation of these random numbers is, subsequently, carried out for the time steps t₀=0.000, t₁=1.000, t₂=1.500, t₃=2.000, t₄=2.750, t₅=3.000 and t₆=4.000. In this case, for the purpose of simple representation, after precise calculation, the calculated values are cut off after the third decimal place. For easier assignment of the vectors and matrices used, the index of the time step for which this variable was respectively calculated is specified in brackets in each case. Thus, C(5) specifies the covariance matrix of the time step [t₄, t₅]=[2.750, 3.000], which relates to the points in time t₀, . . . , t₅.

In the calculation example, the value of the spectral value β is always assumed to be 0.5. The value of the intensity constant const is arbitrarily assumed to be 1.0, and d=5 was used as the window size.

FIGS. 3A to 3F show a calculation example for a simulation time step [t₄, t₅]=[2.750, 3.000].

The 1/f-distributed random numbers of the points in time t₁, . . . , t₄ are assumed to be known in the following exemplary embodiment.

FIG. 3A shows a covariance matrix C(5) of dimension (n×n)=(5×5) that is required for generating a further random number. The covariance matrix C(5) is determined according to equation (3.6).

By way of example, this is carried out on the element C(5,4), that is to say C(i,j) where i=5 and j=4.

Using equation (3.6), C(5,4) results as:

$$1.0 . ( - \vert {t}_{4} - {t}_{5} {\vert}^{05 + 1} + \vert {t}_{4 - 1} - {t}_{5} {\vert}^{05 + 1} + \vert {t}_{4} - {t}_{5 - 1} {\vert}^{05 + 1} + \vert {t}_{4 - 1} - {t}_{5 - 1} {\vert}^{05 + 1} ) = ( - \vert 2.750 - 3.000 {\vert}^{15} + \vert 2.000 - 3.000 {\vert}^{15} + \vert 2.750 - 2.750 {\vert}^{15} - \vert 2.000 - 2.750 {\vert}^{15} ) = - 0.125 + 1 + 0 - 0.649 = 0.225$$

In the next simulation step, the running variable n exceeds the window size d and, thus, the dimension of the covariance matrix C(6). Accordingly, in FIGS. 3B, 3C, 3E, and 3F, auxiliary parameters are determined that are required for the determination of the inverted covariance matrix B(6) of the next simulation time step n=6.

FIG. 3B shows a vector c₁₂^{T}(5) determined from the covariance matrix C(5). The vector c₁₂^{T}(5) includes the second, third, fourth, and fifth elements of the first row of the covariance matrix C(5) and results from equation (3.11).

FIG. 3C shows a submatrix C₂₂(5) determined from the covariance matrix C(5). The submatrix C₂₂(5) contains the elements of the ((d−1)×(d−1))=(4×4)-sized window, which is disposed at the bottom right in the covariance matrix C(5). The submatrix C₂₂(5) results from the covariance matrix C(5) using equation (3.11).

FIG. 3D shows an inverted covariance matrix C⁻¹(5)=B(5) with respect to the covariance matrix C(5), which is designated exclusively as B(5) hereinafter. A check using equation (3.13) shows that matrix multiplication of the covariance matrix C(5) by the inverted covariance matrix B(5) produces the unit matrix I_{d}.

In the present case, the inverted covariance matrix B(5) was calculated explicitly from the covariance matrix C(5) using a Cholesky decomposition (not specifically illustrated here).

FIG. 3E shows a vector b₁₂(5) determined from the inverted covariance matrix B(5). The vector b₁₂(5) contains the second, third, fourth, and fifth elements of the first column of the inverted covariance matrix B(5). The vector b₁₂(5) results from the inverted covariance matrix B(5) using equation (3.12).

FIG. 3F shows a submatrix B₂₂(5) of the inverted covariance matrix B(5) of FIG. 3D. This submatrix B₂₂(5) includes those elements of the inverted covariance matrix B(5) that are contained in the bottom right window of dimension ((d−1)×(d−1))=(4×4) of the inverted covariance matrix B(5). The submatrix B₂₂(5) results from the inverted covariance matrix B(5) using equation (3.12).

The variable σ can, then, be calculated from the element disposed at the bottom right in the inverted covariance matrix B(5), namely, the value B(5)_{5;5}=4.787.

In the present exemplary embodiment, σ results as:

σ=\sqrt{1/e(n,n)}=\sqrt{1/4.787}=0.457

Using the vector:

b(5)_{5;1, . . . , 4}=(−0.094, −0.109, −0.093, −0.749),

which contains the first, second, third, and fourth the fifth row of the inverted covariance matrix B(5), the value μ can be calculated. Formula (3.9) is used in this case.

Using the variables σ and μ thus determined, and also using randomly extracted, normally distributed random numbers x(n), it is possible to calculate y(5) according to the formula

y(n)=x(n)·σ+μ.

In such a case, y(5) represents the fifth element of the vector y that has a sequence of random numbers that are approximated to random numbers of a 1/f noise.

FIGS. 4A to 4C show a calculation example for a sixth simulation time step [t₅, t₆]=[3.000, 4.000]. The value of the running variable n is always equal to 6 for the sixth simulation time step.

FIG. 4A shows an inverted submatrix C₂₂⁻¹(5) with respect to the submatrix C₂₂(5) of FIG. 3C. The inverted submatrix C₂₂⁻¹(5) is not explicitly totally recalculated, but, rather, is produced using equation (3.16).

The auxiliary variables b₁₂(5), c₁₂^{T}(5), and also B₂₂(5) that are required in equation (3.16) for calculating the inverted submatrix C₂₂⁻¹(5) have been determined in the preceding steps. The variable I_{d-1} in equation (3.16) corresponds to the unit matrix for the dimension (d−1)=4.

FIG. 4B shows a covariance matrix C*(6) of dimension (d×d)=(5×5). C*(6) is produced as the bottom right window (2, . . . , 6; 2, . . . , 6) of the covariance matrix C(6) with the dimension d=6.

For the calculation of the covariance matrix C*(6), recourse is had to the submatrix C₂₂(5) that is shown in FIG. 3C and forms the top left window of dimension ((d−1)×(d−1))=(4×4) in the covariance matrix C*(6). Accordingly, only those elements of the covariance matrix C*(6) shown in FIG. 4b that are disposed in the fifth row or in the fifth column are recalculated.

By way of example, such a calculation is carried out using equation (3.6) for the element C(3,6):

$$1.0 . ( - \vert {t}_{6} - {t}_{6} {\vert}^{05 + 1} + \vert {t}_{6 - 1} - {t}_{3} {\vert}^{05 + 1} + \vert {t}_{6} - {t}_{3 - 1} {\vert}^{05 + 1} - \vert {t}_{6 - 1} - {t}_{3 - 1} {\vert}^{05 + 1} ) = ( - \vert 4.000 - 2.000 {\vert}^{15} + \vert 3.000 - 2.000 {\vert}^{1.5} + \vert 4.000 - 1.500 {\vert}^{15} - \vert 3.000 - 1.500 {\vert}^{15} ) = - 2.828 + 1 + 3.952 - 1.837 = 0.287$$

FIG. 4C shows the inverted covariance matrix B*(6) of dimension d=5 with respect to the covariance matrix C*(6) of FIG. 4B.

A check using equation (3.13) reveals that the covariance matrix C*(6) shown in FIG. 4B multiplied by the inverted covariance matrix B*(6) shown in FIG. 4C produces the unit matrix I_{d}.

The inverted covariance matrix B*(6) is not explicitly recalculated element by element, but, rather, is produced by Schur complement techniques using the auxiliary variables shown in FIGS. 3A TO 3F and those shown in FIG. 4A.

Using the bottom right value of the inverted covariance matrix B*(6), namely, the value B*(6)_{5;5}=0.630, σ results as 1.259. Using the vector

B*(6)_{5;1, . . . , 4}=(−0.085, −0.078, −0.139, −0.507)

the value μ can be calculated.

Using the variables σ and μ thus determined and also using extracted, normally distributed random numbers x(n), a further random number y(6) is, then, calculated, which extends the vector y(n) of the random numbers approximated to random numbers of a 1/f noise.

The vector y(n) can be extended as desired by the method according to the invention. During such a calculation, the covariance matrix C(n), and the inverted covariance matrix B(n) thereof, required for determining the random numbers are limited in terms of the dimension n to the predetermined window size d. Such a measure keeps the computation complexity small enough for each simulation time step. Although the random numbers thus generated do not exactly match the random numbers of a 1/f noise, they, nevertheless, represent a very good approximation to them.

I claim:

1. A method for a numerical simulation of a technical system subject to a 1/f noise and having at least one input channel, which comprises:
determining a desired spectral value β;
determining an intensity constant const;
determining a number of random numbers to be generated;
defining a start value for a running variable n;
defining a window size d;
repeating the following steps in a loop until a desired number of elements y(n) of a vector y of length n has been calculated from 1/f-distributed random numbers:
a) incrementing a present value of the running variable n by 1;
b) defining a simulation time step [tₙ₋₁; tₙ] and:
when n<d:
c) determining elements Cᵢⱼ of a covariance matrix C(n) of dimension (n×n) according to the formula:
Cᵢⱼ:=const·(−|tⱼ−tᵢ|^{β+1}+|tⱼ₋₁−tᵢ|^{β+1}+|tⱼ−tᵢ₋₁|^{β+1}−|tⱼ₋₁−tᵢ₋₁|^{β+1}),
where i,j=1, . . . , n;
d) determining an inverted covariance matrix C⁻¹(n)=B(n) of dimension (n×n);
g) determining a variable σ according to the formula:
σ=sqrt(1/e(n,n)),
where:
sqrt is a “square root” function; and
e(n,n) designates an element of the inverted covariance matrix B(n) indexed by (n,n);
h) determining a (0,1)-normally-distributed random number forming an n-th component of a vector x of length n;
i) forming a variable μ from n−1 first components of an n-th row of the inverted covariance matrix B(n) and from n−1 elements of the vector y calculated for a preceding (n−1)-th simulation time step according to the formula:
μ:=−y₍ₙ₋₁₎^{T}·B_{•,n}/B_{n,n}
where:
y₍ₙ₋₁₎ designates n−1 first components of the vector y;
B_{•,n} designates n−1 first components of an n-th row of the inverted covariance matrix B(n), and
B_{n,n} designates an element of the inverted covariance matrix B(n) indexed by (n,n); and
k) calculating an element y(n) of the vector y of length n from 1/f-distributed random numbers according to the formula:
Y(n)=x(n)*σ+μ,
where values of the vector y of the 1/f-distributed random numbers are applied to the input channels of the technical system; and
when n≧d:
e) determining elements Cᵢⱼ of a covariance matrix C(n) of dimension (d×d) according to the formula:
Cᵢⱼ:=const·(−|tⱼ−tᵢ|^{β+1}+|tⱼ₋₁−tᵢ|^{β+1}+|tⱼ−tᵢ₋₁|^{β+1}−|tⱼ₋₁−tᵢ₋₁|^{β+1}),
where i,j=(n−d+1), . . . , n;
f) determining an inverted covariance matrix C⁻¹(n)=B(n) of dimension (d×d);
g) determining a variable σ according to the formula:
σ=sqrt(1/e(n,n)),
where:
sqrt is a “square root” function; and
e(n,n) designates an element of the inverted covariance matrix B(n) indexed by (n,n);
h) determining a (0,1)-normally-distributed random number forming an n-th component of a vector x of length n;
j) forming a variable μ from d−1 first components of an n-th row of the inverted covariance matrix B(n) and from d−1 last elements of the vector y calculated for a preceding (n−1)-th simulation time step according to the formula:
μ:=−y₍ₙ₋₁₎^{T}·B_{•,n}/B_{n,n}
where:
y₍ₙ₋₁₎ designates the last (d−1) components of the vector y;
B_{•,n} designates d−1 first components of an n-th row of the inverted covariance matrix B(n); and
B_{n,n} designates an element of the inverted covariance matrix B(n) indexed by (n,n); and
k) calculating an element y(n) of the vector y of length n from 1/f-distributed random numbers according to the formula:
Y(n)=x(n)*σ+μ,
where values of the vector y of the 1/f-distributed random numbers are applied to the input channels of the technical system.

2. A method for generating at least one sequence of random numbers approximated to sequences of numbers of a 1/f noise for a numerical simulation of a technical system subject to a 1/f noise on a computer system, which comprises:
determining a desired spectral value β;
determining an intensity constant const;
determining a number of random numbers to be generated;
defining a start value for a running variable n;
defining a window size d;
repeating the following steps in a loop until a desired number of elements y(n) of a vector y of length n has been calculated from 1/f-distributed random numbers:
a) incrementing a present value of the running variable n by 1;
b) defining a simulation time step [tₙ₋₁; tₙ] and:
when n<d:
c) determining elements Cᵢⱼ of a covariance matrix C(n) of dimension (n×n) according to the formula:
Cᵢⱼ:=const·(−|tⱼ−tᵢ|^{β+1}+|tⱼ₋₁−tᵢ|^{β+1}+|tⱼ−tᵢ₋₁|^{β+1}−|tⱼ₋₁−tᵢ₋₁|^{β+1}),
where i,j=1, . . . , n;
d) determining an inverted covariance matrix C⁻¹(n)=B(n) of dimension (n×n);
g) determining a variable σ according to the formula:
σ=sqrt(1/e(n,n)),
where:
sqrt is a “square root” function; and
e(n,n) designates an element of the inverted covariance matrix B(n) indexed by (n,n);
h) determining a (0,1)-normally-distributed random number forming an n-th component of a vector x of length n;
i) forming a variable μ from n−1 first components of an n-th row of the inverted covariance matrix B(n) and from n−1 elements of the vector y calculated for a preceding (n−1)-th simulation time step according to the formula:
μ:=−y₍ₙ₋₁₎^{T}·B_{•,n}/B_{n,n}
where:
y₍ₙ₋₁₎ designates n−1 first components of the vector y;
B_{•,n} designates n−1 first components of an n-th row of the inverted covariance matrix B(n), and
B_{n,n} designates an element of the inverted covariance matrix B(n) indexed by (n,n); and
k) calculating an element y(n) of the vector y of length n from 1/f-distributed random numbers according to the formula:
Y(n)=x(n)*σ+μ,
where values of the vector y of the 1/f-distributed random numbers are applied to the input channels of the technical system; and
when n≧d:
e) determining elements Cᵢⱼ of a covariance matrix C(n) of dimension (d×d) according to the formula:
$${\underline{\underline{C}}}_{ij} := const \cdot ( - {\vert {t}_{j} - {t}_{i} \vert}^{β + 1} + {\vert {t}_{j - 1} - {t}_{i} \vert}^{β + 1} + {\vert {t}_{j} - {t}_{i - 1} \vert}^{β + 1} - {\vert {t}_{j - 1} - {t}_{i - 1} \vert}^{β + 1} ) , where i , j = ( n - d + 1 ) , … , n ;$$
f) determining an inverted covariance matrix C⁻¹(n)=B(n) of dimension (d×d);
g) determining a variable σ according to the formula:
σ=sqrt(1/e(n,n)),
where:
sqrt is a “square root” function; and
e(n,n) designates an element of the inverted covariance matrix B(n) indexed by (n,n);
h) determining a (0,1)-normally-distributed random number forming an n-th component of a vector x of length n;
j) forming a variable μ from d−1 first components of an n-th row of the inverted covariance matrix B(n) and from d−1 last elements of the vector y calculated for a preceding (n−1)-th simulation time step according to the formula:
$$μ := - \frac{{y}_{( n - 1 )}^{T} \cdot {\underline{\underline{B}}}_{\cdot , n}}{{\underline{\underline{B}}}_{n , n}}$$
where:
y₍ₙ₋₁₎ designates the last (d−1) components of the vector y;
B_{•,n} designates d−1 first components of an n-th row of the inverted covariance matrix B(n); and
B_{n,n} designates an element of the inverted covariance matrix B(n) indexed by (n,n); and
k) calculating an element y(n) of the vector y of length n from 1/f-distributed random numbers according to the formula:
Y(n)=x(n)*σ+μ,
where values of the vector y of the 1/f-distributed random numbers are applied to the input channels of the technical system.

3. The method according to claim 1, which comprises carrying out step f) by:
f1) determining a vector C₁₂^{T}(n) and a matrix C₂₂(n) from the covariance matrix C(n) according to:
$$C ( n ) = ( \frac{{c}_{11} ( n )}{{c}_{12} ( n )} \vert \frac{{c}_{12}^{T} ( n )}{{C}_{22} ( n )} ) ;$$
f2) determining an inverted covariance matrix C⁻¹(n)=B(n) of dimension (d×d) utilizing an inverted matrix C₂₂⁻¹(n−1) by Schur complement techniques;
f3) determining a vector b₁₂(n) and a matrix B₂₂(n) from the inverted covariance matrix B(n) according to:
$$B ( n ) = ( \frac{{b}_{11} ( n )}{{b}_{12} ( n )} \vert \frac{{b}_{12}^{T} ( n )}{{B}_{22} ( n )} ) ; and$$
f4) determining an inverted matrix C₂₂⁻¹(n) according to:
$${C}_{22}^{- 1} ( n ) = {( {I}_{d - 1} - {b}_{12} ( n ) {c}_{12}^{T} ( n ) )}^{- 1} \cdot {B}_{22} ( n )$$
where I_{d-1} is a unit matrix of dimension ((d−1)×(d−1)).

4. The method according to claim 2, which comprises carrying out step f) by:
f1) determining a vector C₁₂^{T}(n) and a matrix C₂₂(n) from the covariance matrix C(n) according to:
$$C ( n ) = ( \frac{{c}_{11} ( n )}{{c}_{12} ( n )} \vert \frac{{c}_{12}^{T} ( n )}{{C}_{22} ( n )} ) ;$$
f2) determining an inverted covariance matrix C⁻¹(n)=B(n) of dimension (d×d) utilizing an inverted matrix C₂₂⁻¹(n−1) by Schur complement techniques;
f3) determining a vector b₁₂(n) and a matrix B₂₂(n) from the inverted covariance matrix B(n) according to:
$$B ( n ) = ( \frac{{b}_{11} ( n )}{{b}_{12} ( n )} \vert \frac{{b}_{12}^{T} ( n )}{{B}_{22} ( n )} ) ; and$$
f4) determining an inverted matrix C₂₂⁻¹(n) according to:
$${C}_{22}^{- 1} ( n ) = {( {I}_{d - 1} - {b}_{12} ( n ) {c}_{12}^{T} ( n ) )}^{- 1} \cdot {B}_{22} ( n )$$
where I_{d-1} is a unit matrix of dimension ((d−1)×(d−1)).

5. A method for a numerical simulation of a technical system subject to a 1/f noise and having at least one input channel, which comprises:
determining a desired spectral value β;
determining an intensity constant const;
determining a number of random numbers to be generated;
defining a start value for a running variable n;
defining a window size d;
calculating q sequences of random numbers of a 1/f noise simultaneously by:
a) incrementing a present value of the running variable n by 1;
b) defining a simulation time step [tₙ₋₁; tₙ] and:
when n<d:
c) determining elements Cᵢⱼ of a covariance matrix C(n) of dimension (n×n) according to the formula:
$${\underline{\underline{C}}}_{ij} := const \cdot ( - {\vert {t}_{j} - {t}_{i} \vert}^{β + 1} + {\vert {t}_{j - 1} - {t}_{i} \vert}^{β + 1} + {\vert {t}_{j} - {t}_{i - 1} \vert}^{β + 1} - {\vert {t}_{j - 1} - {t}_{i - 1} \vert}^{β + 1} ) ,$$
where i,j=1, . . . , n;
d) determining an inverted covariance matrix C⁻¹(n)=B(n) of dimension (n×n);
g) determining a variable σ according to the formula:
σ=sqrt(1/e(n,n)),
where:
sqrt is a “square root” function; and
e(n,n) designates an element of the inverted covariance matrix B(n) indexed by (n,n);
h′) determining q (0,1)-normally-distributed random numbers x_{k,n} forming a respective last component of vectors xₖ of length n, where k=1, . . . , q;
i′) forming q variables μₖ according to the formula:
$${μ}_{k} := - \frac{{y}_{( n - 1 ) , k}^{T} \cdot {\underline{\underline{B}}}_{\cdot , n}}{{\underline{\underline{B}}}_{n , n}}$$
where y_{(n-1),k} is n−1 first components of a vector yₖ calculated for a preceding simulation time step, where k=1, . . . , q;
k′) calculating q elements y_{k,n} forming a respective n-th component of the vector yₖ of length n from 1/f-distributed random numbers according to the formula:
y_{k,n}=x_{k,n}*σ+μₖ
where k=1, . . . , q; and
when n≧d:
e) determining elements Cᵢⱼ of a covariance matrix C(n) of dimension (d×d) according to the formula:
$${\underline{\underline{C}}}_{ij} := const . ( - \vert {t}_{j} - {t}_{i} {\vert}^{β + 1} + \vert {t}_{j - 1} - {t}_{i} {\vert}^{β + 1} + \vert {t}_{j} - {t}_{i - 1} {\vert}^{β + 1} - \vert {t}_{j - 1} - {t}_{i - 1} {\vert}^{β + 1} ) ,$$
where i,j=(n−d+1), . . . , n;
f) determining an inverted covariance matrix C⁻¹(n)=B(n) of dimension (d×d);
g) determining a variable σ according to the formula:
σ=sqrt(1/e(n,n)),
where:
sqrt is a “square root” function; and
e(n,n) designates an element of the inverted covariance matrix B(n) indexed by (n,n);
h′) determining q (0,1)-normally-distributed random numbers x_{k,n} forming a respective last component of vectors xₖ of length n, where k=1, . . . , q;
j′) forming q variables μₖ according to the formula:
$${μ}_{k} := - \frac{{y}_{( n - 1 ) , k}^{T} \cdot {\underline{\underline{B}}}_{• , n}}{{\underline{\underline{B}}}_{n , n}}$$
where y_{(n-1),k} is d−1 last components of a vector yₖ calculated for a preceding simulation time step, where k=1, . . . , q;
k′) calculating q elements y_{k,n} forming a respective n-th component of the vector yₖ of length n from 1/f-distributed random numbers according to the formula:
y_{k,n}=x_{k,n}*σ+μₖ
where k=1, . . . , q.

6. A method for generating at least one sequence of random numbers approximated to sequences of numbers of a 1/f noise for a numerical simulation of a technical system subject to a 1/f noise on a computer system, which comprises:
determining a desired spectral value β;
determining an intensity constant const;
determining a number of random numbers to be generated;
defining a start value for a running variable n;
defining a window size d;
calculating q sequences of random numbers of a 1/f noise simultaneously by:
a) incrementing a present value of the running variable n by 1;
b) defining a simulation time step [tₙ₋₁; t_{n] and:}
when n<d:
c) determining elements Cᵢⱼ of a covariance matrix C(n) of dimension (n×n) according to the formula:
$${\underline{\underline{C}}}_{ij} := const . ( - \vert {t}_{j} - {t}_{i} {\vert}^{β + 1} + \vert {t}_{j - 1} - {t}_{i} {\vert}^{β + 1} + \vert {t}_{j} - {t}_{i - 1} {\vert}^{β + 1} - \vert {t}_{j - 1} - {t}_{i - 1} {\vert}^{β + 1} ) ,$$
where i,j=1, . . . , n;
d) determining an inverted covariance matrix C⁻¹(n)=B(n) of dimension (n×n);
g) determining a variable σ according to the formula:
σ=sqrt(1/e(n,n)),
where:
sqrt is a “square root” function; and
e(n,n) designates an element of the inverted covariance matrix B(n) indexed by (n,n);
h′) determining q (0,1)-normally-distributed random numbers x_{k,n} forming a respective last component of vectors xₖ of length n, where k=1, . . . , q;
i′) forming q variables μₖ according to the formula:
$${μ}_{k} := - \frac{{y}_{{}_{( n - 1 ) , k}^{T} \cdot } {\underline{\underline{B}}}_{• , n}}{{\underline{\underline{B}}}_{n , n}}$$
where y_{(n-1),k} is n−1 first components of a vector yₖ calculated for a preceding simulation time step, where k=1, . . . , q;
k′) calculating q elements y_{k,n} forming a respective n-th component of the vector yₖ of length n from 1/f-distributed random numbers according to the formula:
y_{k,n}=x_{k,n}*σ+μₖ
where k=1, . . . , q; and
when n≧d:
e) determining elements Cᵢⱼ of a covariance matrix C(n) of dimension (d×d) according to the formula:
$${\underline{\underline{C}}}_{ij} := const \cdot ( - \vert {t}_{j} - {t}_{i} {\vert}^{β + 1} + \vert {t}_{j - 1} - {t}_{i} {\vert}^{β + 1} + \vert {t}_{j} - {t}_{i - 1} {\vert}^{β + 1} - \vert {t}_{j - 1} - {t}_{i - 1} {\vert}^{β + 1} ) ,$$
where i,j=(n−d+1), . . . , n;
f) determining an inverted covariance matrix C⁻¹(n)=B(n) of dimension (d×d);
g) determining a variable σ according to the formula:
σ=sqrt(1/e(n,n)),
where:
sqrt is a “square root” function; and
e(n,n) designates an element of the inverted covariance matrix B(n) indexed by (n,n);
h′) determining q (0,1)-normally-distributed random numbers x_{k,n} forming a respective last component of vectors xₖ of length n, where k=1, . . . , q;
j′) forming q variables μₖ according to the formula:
$${μ}_{k} := - \frac{{y}_{{}_{( n - 1 ) , k}^{T} \cdot } {\underline{\underline{B}}}_{• , n}}{{\underline{\underline{B}}}_{n , n}}$$
where y_{(n-1),k} is d−1 last components of a vector yₖ calculated for a preceding simulation time step, where k=1, . . . , q;
k′) calculating q elements y_{k,n} forming a respective n-th component of the vector yₖ of length n from 1/f-distributed random numbers according to the formula:
y_{k,n}=x_{k,n}*σ+μₖ
where k=1, . . . , q.

7. The method according to claim 1, wherein the technical system is an electronic component.

8. The method according to claim 7, wherein the electronic component is a component selected from the group consisting of a pn diode, a MOS field-effect transistor, and a phase-locked loop.

9. The method according to claim 2, wherein the technical system is an electronic component.

10. The method according to claim 9, wherein the electronic component is a component selected from the group consisting of a pn diode, a MOS field-effect transistor, and a phase-locked loop.

11. The method according to claim 5, wherein the technical system is an electronic component.

12. The method according to claim 11, wherein the electronic component is a component selected from the group consisting of a pn diode, a MOS field-effect transistor, and a phase-locked loop.

13. The method according to claim 6, wherein the technical system is an electronic component.

14. The method according to claim 13, wherein the electronic component is a component selected from the group consisting of a pn diode, a MOS field-effect transistor, and a phase-locked loop.

15. A computer-readable storage medium, comprising:
a storage storing a computer program executing the steps of the method of claim 1.

16. A computer-readable storage medium, comprising:
a storage storing a computer program executing the steps of the method of claim 2.

17. A computer-readable storage medium, comprising:
a storage storing a computer program executing the steps of the method of claim 5.

18. A computer-readable storage medium, comprising:
a storage storing a computer program executing the steps of the method of claim 6.

19. A computer memory, comprising:
a memory area storing a program executing the steps of the method of claim 1.

20. A computer memory, comprising:
a memory area storing a program executing the steps of the method of claim 2.

21. A computer memory, comprising:
a memory area storing a program executing the steps of the method of claim 5.

22. A computer memory, comprising:
a memory area storing a program executing the steps of the method of claim 6.

23. A memory, comprising:
a random access memory area storing a program executing the steps of the method of claim 1.

24. A memory, comprising:
a random access memory area storing a program executing the steps of the method of claim 2.

25. A memory, comprising:
a random access memory area storing a program executing the steps of the method of claim 5.

26. A memory, comprising:
a random access memory area storing a program executing the steps of the method of claim 6.

27. A computer system, comprising:
a processor;
a receiver for receiving an electrical carrier signal, said receiver connected to said processor; and
a memory connected to said processor and storing a computer program received as an electrical carrier signal through said receiver, said program executing the steps of the method of claim 1.

28. A computer system, comprising:
a processor;
a receiver for receiving an electrical carrier signal, said receiver connected to said processor; and
a memory connected to said processor and storing a computer program received as an electrical carrier signal through said receiver, said program executing the steps of the method of claim 2.

29. A computer system, comprising:
a processor;
a receiver for receiving an electrical carrier signal, said receiver connected to said processor; and
a memory connected to said processor and storing a computer program received as an electrical carrier signal through said receiver, said program executing the steps of the method of claim 5.

30. A computer system, comprising:
a processor;
a receiver for receiving an electrical carrier signal, said receiver connected to said processor; and
a memory connected to said processor and storing a computer program received as an electrical carrier signal through said receiver, said program executing the steps of the method of claim 6.

31. A data carrier, comprising:
a data area storing a program executing the steps of the method of claim 1.

32. A data carrier, comprising:
a data area storing a program executing the steps of the method of claim 2.

33. A data carrier, comprising:
a data area storing a program executing the steps of the method of claim 5.

34. A data carrier, comprising:
a data area storing a program executing the steps of the method of claim 6.

35. A method for simulating a 1/f noise, which comprises:
connecting a computer to an electronic data network;
downloading a computer program for executing the steps of the method of claim 1; and
executing computer program on the computer.

36. The method according to claim 35, wherein the electronic data network is the Internet.

37. A method for simulating a 1/f noise, which comprises:
connecting a computer to an electronic data network;
downloading a computer program for executing the steps of the method of claim 2; and
executing computer program on the computer.

38. The method according to claim 37, wherein the electronic data network is the Internet.

39. A method for simulating a 1/f noise, which comprises:
connecting a computer to an electronic data network;
downloading a computer program for executing the steps of the method of claim 5; and
executing computer program on the computer.

40. The method according to claim 39, wherein the electronic data network is the Internet.

41. A method for simulating a 1/f noise, which comprises:
connecting a computer to an electronic data network;
downloading a computer program for executing the steps of the method of claim 6; and
executing computer program on the computer.

42. The method according to claim 41, wherein the electronic data network is the Internet.
